(19) United States
(12) Patent Application Publication
(10) Pub. No.: US 2020/0311886 A1
(43) Pub. Date: Oct. 1, 2020

(54) Method for determining an image recording aberration

(71) Applicant: Carl Zeiss Microscopy GmbH, Jena (DE)

(72) Inventors: Josef Biberger, Wildenberg (DE); Simon Diemer, Lauchheim (DE)

(21) Appl. No.: 16/831,968

(22) Filed: Mar. 27, 2020

(30) Foreign Application Priority Data
Mar. 28, 2019 (DE) 102019108005.3

(51) Int. Cl. G06T 5/00; G02B 21/36

(52) U.S. Cl. CPC G06T 5/006; G06T 2207/10056; G02B 21/365

(57) ABSTRACT

A method for determining and correcting an image recording aberration of an image recording device includes recording a first image using an image recording device. The first image represents a first region of an object. The method also includes recording second images using the image recording device. The second images represent mutually different partial regions of the first region. Each partial region is smaller than the first region. The method further includes determining at least one value of an image recording aberration of the image recording device on the basis of the first image and the second images. Related devices are disclosed.

### CROSS REFERENCE TO RELATED APPLICATION

The present application claims benefit under 35 USC 119 of German Application Serial No. 10 2019 108 005.3, filed Mar. 28, 2019. The entire contents of this application are incorporated by reference herein.

### FIELD

The present disclosure relates to a method for determining an image recording aberration of an image recording device. In particular, the present disclosure relates to image recording devices which include a light-optical imaging device or a particle beam device for the purpose of generating images of an object.

### BACKGROUND

Image recording devices including a light-optical imaging device are, for example, light microscopes having an imaging device for light in the visible spectral range. The imaging device images an object plane into an image plane. A light image detector can be arranged in the image plane, and can record a (digital) image of the object by detecting in a spatially resolved manner the light which emanates from the object and is imaged into the image plane by the imaging device. In this case, there is often the issue that the imaging device generates imaging aberrations, which increase with increasing distance from an optical axis of the imaging device. This means that the edge regions of the recorded image are affected by imaging aberrations of the imaging device to a greater extent than regions near the optical axis.

Image recording devices using a particle beam device are electron beam microscopes or ion beam microscopes, for example. In this case, a primary particle beam composed of electrons or ions is generated and directed onto an object of which an image is intended to be recorded. As a result of interaction between the primary particle beam and the object, secondary particles (for example electrons, ions and/or radiation (x-ray radiation, cathodoluminescence, etc.) are generated, which emanate from the object and can be detected. By scanning the primary particle beam over the object and detecting the secondary particles generated in the process, it is possible to record an image of the object. In this case, there is often the issue that the accuracy of the deflection of the primary particle beam decreases with increasing distance from a particle-optical axis of a particle beam optical unit that focusses the primary particle beam. This means that the edge regions of the recorded image are affected by deflection aberrations to a greater extent than regions near the optical axis.

### SUMMARY

The present disclosure seeks to determine image recording aberrations that occur during the recording of an image using an image recording device and to improve the recorded images or the recording of further images using the image recording aberrations determined.

In accordance with one aspect of the disclosure, a method for determining an image recording aberration includes: recording a first image using an image recording device, wherein the first image represents a first region of an object, recording second images using the image recording device; wherein the second images represent mutually different partial regions of the first region, wherein each of the partial regions is smaller than the first region; and determining at least one value of an image recording aberration of the image recording device on the basis of the first image and the second images.

The image recording device can include for example a microscope, in particular a light microscope, an electron beam microscope, an ion beam microscope or an x-ray microscope.

A light microscope includes a light-optical imaging device configured to image an object plane, in which the object can be arranged, into an image plane, where the imaged light emanating from the object can be perceived or detected. By way of example, the light microscope includes an image sensor arranged in the image plane and configured to detect in a spatially resolved manner the light impinging on a detection area of the image sensor. A signal representing in a spatially resolved manner the light that impinged on the detection area can be output by the image sensor and be received and processed further by a controller. Accordingly, the image recording device can record digital images which can be received and processed further by the controller.

The image recording device can be a particle beam system, for example an electron beam microscope or an ion beam microscope. The particle beam system includes a device for generating a primary particle beam composed of electrons or ions, a focussing device for focussing the primary particle beam and a deflector device for deflecting the primary particle beam with respect to a particle-optical axis of the focussing device. As a result, the primary particle beam can be scanned over an object which can be arranged in a focal plane produced by the focussing device. Interaction between the primary particle beam and the object generates secondary particles (for example backscattered electrons, secondary electrons, backscattered ions, secondary ions, radiation, in particular x-ray radiation, cathodoluminescence), which can be detected by a secondary particle detector of the particle beam system. The secondary particle detector can output a signal representing the detected secondary particles. Together with information about the deflection of the primary particle beam (and the positioning of the object with respect to the particle beam system), a spatially resolved distribution of the detected secondary particles can be determined. Images of the object can thus be recorded using the particle beam system.

Depending on the type of image recording device, various image recording aberrations occur during the recording of an image using the image recording device.

In the case of light microscopes, the image recording aberrations are caused by the imaging device, for example. Distortion aberrations between the object plane and the image plane can occur as a result. Examples of “conventional” distortions in the case of light microscopes are a pincushion distortion and a barrel distortion.

In the case of particle beam systems, the image recording aberrations can be caused by the focussing device and the deflector device. If the object is scanned for example with a non-uniform speed of the primary particle beam on the object, a dynamic distortion can occur. Moreover, non-linearities in components of the deflector device can lead to an inhomogeneous magnification.

Distortion aberrations of light microscopes, dynamic distortions and inhomogeneous magnifications in particle beam systems have the consequence that a recorded image of an object has image recording aberrations which consist in the fact that the spatial arrangement of locations of the object (also referred to hereinafter as object locations) is not reproduced exactly in the image, but rather is altered.

The present method can be used to determine image recording aberrations of image recording devices which are dependent on the size of the field of view of an image recording. In the case of light microscopes, the field of view is that region of the object plane which is imaged into the image plane by the imaging device, is detected there and is used for generating an image.

Accordingly, the field of view is also dependent on the size of the detection area of an image sensor arranged in the image plane, and on the magnification of the imaging device. In addition, the field of view is dependent on the size of that region of the detection area of the image sensor which is actually used for generating the image. The field of view and the image thus generated are therefore directly dependent on one another.

In the case of particle beam systems, the field of view corresponds to that region of the object which is scanned by the primary particle beam and from which secondary particles emanate as a result, which are detected and are used for generating an image. The size of the field of view is accordingly related directly to the size of the generated image, but not to the magnification.

In accordance with the method, a first image is recorded using the image recording device, wherein the first image represents the first region of the object. This means that the first image is a recording of the first region of the object.

Furthermore, second images of the object are recorded by the same image recording device, wherein the second images represent mutually different partial regions of the first region. Each of the second images is a recording of a partial region of the first region, i.e. each of the partial regions covers a part of the first region. The second images are recordings of different partial regions of the first region. The partial regions are in each case smaller than the first region. The area of the partial regions and of the first region can be used as a comparison measure. Accordingly, the area of each of the partial regions can be smaller than the area of the first region.

For the purpose of recording the second images, the object can be moved relative to the image recording device before the recording of a next second image in order thus to record different partial regions of the first region.

The second images have smaller image recording aberrations in comparison with the first image since the partial regions are smaller than the first region and the image recording aberrations decrease as the field of view decreases. The smaller the field of view recorded for the purpose of recording an image, the smaller the image recording aberrations of the image.

In accordance with the method, at least one value of an image recording aberration of the image recording device is determined on the basis of the first image and the second images.

Since the image recording aberration is smaller during the recording of the second images than during the recording of the first image, by comparing the first image with the second images it is possible to draw a conclusion about the image recording aberration or the value(s) thereof. Depending on the type of image recording aberration, the determination can be carried out in various ways.

The image recording aberration represents an inhomogeneous magnification between object and image, for example, which is caused by the image recording and thus by the image recording device. An inhomogeneous magnification is present if the magnification cannot be expressed by a simply scalar relationship between the object and the image. One example of an inhomogeneous magnification is distortion. Distortion means that the distance between an object location and the optical axis is mapped non linearly onto the distance between the image location onto which the object location is imaged and the image center. In general, the non linearity increases with increasing distance from the optical axis. An inhomogeneous magnification is also present, for example, if the magnifications along a horizontal axis of the image and a vertical axis of the image are different, such that the magnification varies in a direction dependent manner.

The image recording aberration, that is to say the deviation of an ideal imaging from the real imaging, can be parameterized in various ways. By way of example, the distortion is parameterized by a specification which assigns to each image position of an image a displacement vector indicating the difference between the real image position, to which an object location is imaged by the real imaging, and the ideal image position, to which the object location is imaged by the ideal imaging.

Since the ideal image position is unknown, however, the ideal image position is approximated. The approximation is effected on the basis of the second images or the third image, which are described in detail later. By way of example, the second images or the third image serve(s) as the approximation. Consequently, the image recording aberration can be defined as an array of displacement vectors, wherein each displacement vector represents a distance and a direction between corresponding image positions of the first image and of the second images.

Alternatively, the image recording aberration can be defined as an array of displacement vectors, wherein each displacement vector represents a distance and a direction between corresponding image positions of the first and third images.

The above-described method for determining at least one value of an image recording aberration is based on a plurality of recorded images of an object. The object need not be a reference object configured in a particular way. Instead, for carrying out the method it suffices if the object is represented with sufficient contrast in the images.

In accordance with one advantageous embodiment, the method furthermore includes: determining first intermediate values by image values of the first image and of the second images at corresponding image positions being computed with one another, wherein the at least one value of the image recording aberration of the image recording device is determined on the basis of the first intermediate values.

In accordance with one advantageous embodiment, the method furthermore includes: determining a first assignment, by which corresponding image positions in the first image and the second images are determinable. Accordingly, corresponding image positions in the first image and the second images can be determined via the first assignment.

The first image and the second images are in each case a two-dimensional arrangement of pixels, wherein at least one image value is assigned to each pixel. The pixels can be uniquely specified by two-dimensional discrete indices and occupy a predetermined area region within the image.

In the case of light microscopes configured for recording colour images, a plurality of image values can be assigned to each pixel. By way of example, a total of three image values are assigned to each pixel of a colour image, namely one image value each for the colours red, green and blue. In the case of particle beam systems, the image value corresponds for example to a quantity of detected secondary particles.

Corresponding image positions are positions in different images which represent the same location of the object. In this regard, an image position of the first image and an image position of one of the second images correspond if the two image positions represent the same location of the object.

An image position in an image is a position in the image, wherein the position is uniquely specified by two-dimensional continuous indices. Accordingly, an image position denotes a mathematical point in the image.

Using the first assignment, it is possible to determine what image positions of the first image and of the second images are corresponding image positions. Using the first assignment, it is possible to determine image positions in the first image and the second images which represent the same location of the object. The first assignment can include for example concrete indications of corresponding image positions or can indicate them by a specification which links corresponding image positions in different images with one another.

The first assignment can be determined for example by correlation of the first image with the second images. Computing the image values of the first image and of the second images can include determining a deviation between image values of the first image and of the second images at corresponding image positions determined using the first assignment.

In accordance with a further embodiment, the method furthermore includes generating a third image on the basis of the second images, wherein the third image represents the first region of the object and wherein the at least one value of the image recording aberration is determined on the basis of the third image.

The third image is a two-dimensional arrangement of pixels, wherein at least one image value is assigned to each pixel.

The third image can be generated for example by the second images being combined such that exactly one location of the object is assigned to each pixel of the third image. In this case, the second images, each representing a partial region of the first region, are combined to form a third image, wherein corresponding image regions of the second images, i.e. image regions of the second images which represent the same region of the object, are superimposed. Combining the second images can be carried out for example using a correlation of the second images with one another.

In this embodiment, determining the at least one value of the image recording aberration of the image recording device can include: determining second intermediate values by image values of the first image and of the third image at corresponding image positions being computed with one another, wherein the at least one value of the image recording aberration of the image recording device is determined on the basis of the second intermediate values.

The method can furthermore include: determining a second assignment, by which corresponding image positions in the first and third images are determinable. Accordingly, corresponding image positions in the first image and the third image can be determined using the second assignment.

Using the second assignment, it is possible to determine what image positions of the first image and of the third image are corresponding image positions. Using the second assignment, it is possible to determine image positions in the first image and the third image which represent the same location of the object. The second assignment can include for example concrete indications of corresponding image positions or can indicate them by a specification which links corresponding image positions in different images with one another.

The second assignment can be determined for example by correlation of the first image with the third image. Computing the image values of the first image and of the third image can include determining a deviation between image values of the first image and of the third image at corresponding image positions determined using the second assignment.

In accordance with one exemplary embodiment, the first image is recorded with a first magnification and the second images are recorded with second magnifications, wherein each of the second magnifications is greater than the first magnification. Accordingly, each of the second images can be recorded with a dedicated second magnification. However, it is also possible for all the second images to be recorded with the same second magnification.

In the case of light microscopes, the magnification can be defined as the ratio of the size of the image field to the size of the field of view. The size of the area of the image field and of the field of view can be used as a comparison size. Image field denotes that region in the image plane onto which the field of view is imaged by the imaging device and which is additionally used for generating the image. In the case of light microscopes including an image sensor, the image field maximally has the size of the detection area of the image sensor. However, if the entire detection area of the image sensor is not used for generating an image, the image field is reduced to that region of the detection area of the image sensor which is actually used for generating the image. In this case, the field of view is reduced as well.

In the case of particle beam systems, a larger magnification is achieved by reducing the ratio of the distance between neighbouring scan points (i.e. locations on the object onto which the primary particle beam is directed in order to record an image of the object) to the pixel size in the represented image.

The second magnifications are greater than the first magnification. This can be achieved, for example, by recording the first image and the second images with fields of view of the same size, but with image fields of different sizes, wherein the image field during the recording of the second images is larger than the image field during the recording of the first image. Furthermore, this can be achieved, for example, by recording the first image and the second images with image fields of the same size, but with fields of view of different sizes, wherein the field of view used for recording the first image is larger than the fields of view used for recording the second images. Finally, different magnifications can be achieved by both the fields of view and the image fields during the recording of the first image and of the second images having different sizes. The sizes of the fields of view and of the image fields can be set by the imaging device and the detection area used for image generation.

Since the first magnification, with which the first image is recorded, is smaller than the second magnifications, with which the second images are recorded, the second images have smaller image recording aberrations than the first image.

A ratio of the smallest second magnification to the first magnification can be at least 2, preferably at least 5 or at least 10.

In accordance with a further embodiment, the first image is recorded with a first field of view size (i.e. size of the field of view) and the second images are recorded with second field of view sizes, wherein each of the second field of view sizes is smaller than the first field of view size. Each of the second images can be recorded with a dedicated second field of view size. However, all the second images can be recorded with the same second field of view size.

In particular, the first image and the second images are recorded with different field of view sizes, but with the same magnification. This is achieved for example by the entire detection area of the image sensor of a light microscope being used for recording the first image, while only a partial region of the detection area of the image field of the light microscope is used for recording the second images. As a result, the second images have smaller image recording aberrations than the first image because the second fields of view are smaller than the first field of view and, consequently, fewer regions of the object plane which are far away from the optical axis of the imaging device contribute to generating the second images.

A ratio of the first field of view size to the largest second field of view size is for example at most 2, preferably at most 5 or at most 10.

In the case of particle beam systems, a smaller field of view is achieved by the primary particle beam being scanned over a smaller region of the object. Accordingly, the primary particle beam, for recording the second images, is deflected to a lesser extent than is the case when recording the first image. As a result, the second images have smaller image recording aberrations than the first image.

In accordance with further exemplary embodiments, the partial regions represented by the second images partly overlap. As a result, the location of the second images relative to one another can be determined more simply. Additionally or alternatively, the partial regions together can cover the first region represented by the first image. As a result, for each image position of the first image, a corresponding image position is present in at least one of the second images. During the recording of the first image, the optical axis of the image recording device can pass through the first region. During the recording of the second images, the optical axis of the image recording device can pass through the partial regions. For this purpose, the object is moved relative to the image recording device before the recording of each second image, such that the optical axis of the image recording device passes through the partial region which is subsequently recorded with a second image. What is achieved as a result is that the second images are recorded with a field of view that is situated near the optical axis of the image recording device. The light-optical axis of the imaging device can be defined as the optical axis of a light microscope. The optical axis of a particle beam system can be defined by the particle-optical axis of the focussing device.

In accordance with the methods described herein, the at least one value of the image recording aberration of the image recording device is determined. The at least one value can subsequently be used for correcting an image recorded by the image recording device. Furthermore or alternatively, the at least one value of the image recording aberration determined can be used for controlling the image recording device in order thus to reduce the image recording aberrations during the recording of further images by the image recording device.

By way of example, the first image is corrected on the basis of the at least one value of the image recording aberration determined, by which image processing device. Furthermore or alternatively, a fourth image is recorded using the image recording device. The fourth image can represent a different region of the object compared with the first image and the second images. Accordingly, the fourth image can represent a second region of the object, the second region being different from the first region and the partial regions. The fourth image can be corrected on the basis of the at least one value of the image recording aberration determined, using an image processing device.

By way of example, an operating parameter of the image recording device can be determined on the basis of the at least one value of the image recording aberration determined, in such a way that the image recording aberration is reduced in comparison with the situation during the recording of the first image. In the case of particle beam systems, by way of example, the deflector device can be controlled depending on the at least one value of the image recording aberration determined, such that an image recording aberration caused by the deflection of the primary particle beam is smaller during the recording of further images than during the recording of the first image.

A further aspect of the present disclosure relates to a device configured to carry out the methods described herein. For this purpose, the device can include an image recording device, an image processing device and an image reproduction device. The image recording device can be a light microscope, an electron beam microscope, an ion beam microscope or an x-ray microscope.

### BRIEF DESCRIPTION OF THE DRAWINGS

Embodiments of the disclosure are explained in greater detail below with reference to figures, in which:

FIG. 1 shows a schematic illustration of a first region of an object, a first image of which is recorded using an image recording device;

FIGS. 2A to 2D show a schematic illustration of partial regions of the object, second images of which are recorded using the image recording device;

FIG. 3 shows a schematic illustration for elucidating a first assignment between the first image and the second images;

FIG. 4 shows a schematic illustration of a third image generated by combination of the second images;

FIG. 5 shows a schematic illustration for elucidating a second assignment between the first image and the third image;

FIG. 6 shows a schematic illustration of an image recording device in the form of a light microscope;

FIG. 7 shows a schematic illustration of a further image recording device in the form of a particle beam system;

FIG. 8 shows a schematic illustration of a further image recording device in the form of a further particle beam system;

FIG. 9 shows a schematic illustration for elucidating an image recording aberration in a first image;

FIG. 10 shows a schematic illustration for elucidating an image recording aberration in a second image; and

FIG. 11 shows a schematic illustration of an image recording aberration as determined from the first image shown in FIG. 9 and the second image shown in FIG. 10.

### DETAILED DESCRIPTION

One embodiment of a method for determining an image recording aberration is described below. The method includes recording a first image using an image recording device, wherein the first image represents a first region of an object.

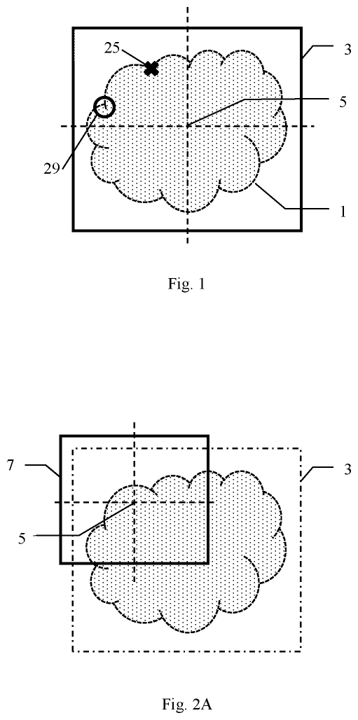

FIG. 1 shows a schematic illustration of an object 1. The object 1 has a rectangular first region 3. The first image is an imaging of the first region 3. The point of intersection of two dashed lines represents an optical axis 5 of the image recording device used to record the first image. The optical axis 5 extends perpendicularly to the image plane in FIG. 1 and passes through the first region 3 during the recording of the first image.

The method furthermore includes recording second images using the image recording device, wherein the second images represent mutually different partial regions of the first region 3, wherein each of the partial regions is smaller than the first region 3.

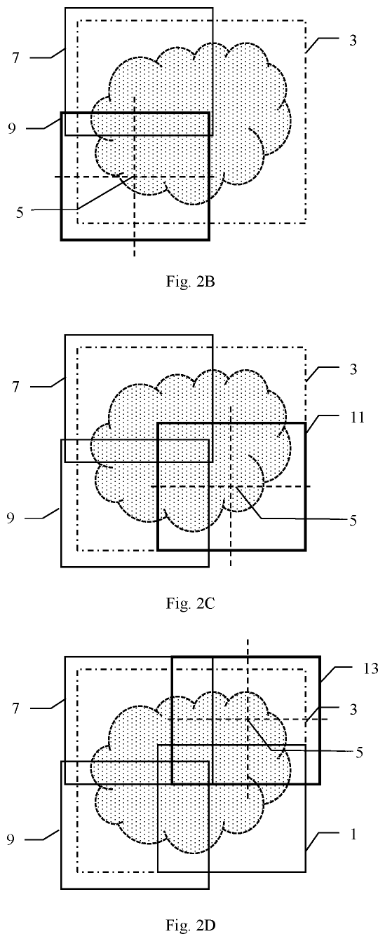

FIGS. 2A to 2D show a schematic illustration of partial regions 7, 9, 11, 13 of the object 1, a second image of each of which is recorded using the image recording device.

FIG. 2A shows a first partial region 7 of the object 1, a second image of which is recorded using the image recording device. During the recording of the second image representing the first partial region 7, the optical axis 5 passes through the first partial region 7. The first partial region 7 is delimited by the rectangle illustrated in a highlighted manner. The first partial region 7 contains a part of the first region 3 and is thus a partial region of the first region 3. The first partial region 7 is smaller than the first region 3. This is illustrated by the first partial region 7 having a smaller area than the first region 3.

FIG. 2B shows a second partial region 9 of the object 1, a further second image of which is recorded using the image recording device. During the recording of the second image representing the second partial region 9, the optical axis 5 passes through the second partial region 9. The second partial region 9 is delimited by the rectangle illustrated in a highlighted manner. The second partial region 9 contains a part of the first region 3 and is thus a partial region of the first region 3. The second partial region 9 is smaller than the first region 3. This is illustrated by the second partial region 9 having a smaller area than the first region 3.

FIG. 2C shows a third partial region 11 of the object 1, a further second image of which is recorded using the image recording device. During the recording of the second image representing the third partial region 11, the optical axis 5 passes through the third partial region 11. The third partial region 11 is delimited by the rectangle illustrated in a highlighted manner. The third partial region 11 contains a part of the first region 3 and is thus a partial region of the first region 3. The third partial region 11 is smaller than the first region 3. This is illustrated by the third partial region 11 having a smaller area than the first region 3.

FIG. 2D shows a fourth partial region 13 of the object 1, a further second image of which is recorded using the image recording device. During the recording of the second image representing the fourth partial region 13, the optical axis 5 passes through the fourth partial region 13. The fourth partial region 13 is delimited by the rectangle illustrated in a highlighted manner. The fourth partial region 13 contains a part of the first region 3 and is thus a partial region of the first region 3. The fourth partial region 13 is smaller than the first region 3. This is illustrated by the fourth partial region 13 having a smaller area than the first region 3.

The first to fourth partial regions 7, 9, 11, 13 are mutually different partial regions of the first region 3. The first to fourth partial regions 7, 9, 11, 13 have regions overlapping in pairs. Together the first to fourth partial regions 7, 9, 11, 13 cover the first region 3 (and regions beyond that) of the object 1.

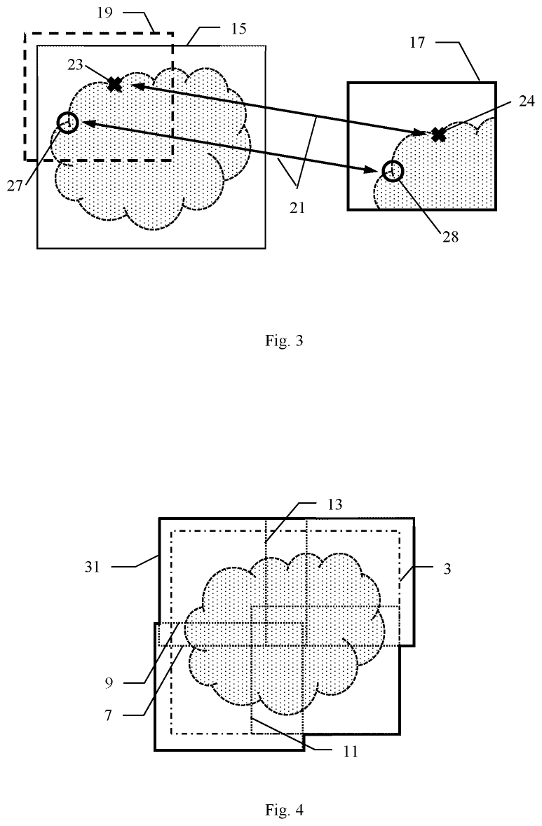

In accordance with this embodiment, the method furthermore includes determining a first assignment, by which corresponding image positions in the first image and the second images are determinable. FIG. 3 is a schematic illustration for elucidating the first assignment.

FIG. 3 shows the first image 15 representing the first region 3. Furthermore, FIG. 3 shows that one of the second images 17 which represents the first partial region 7. The second image 17 which represents the first partial region 7 is used hereinafter in a manner representative of every other second image from among the second images 17. A frame 19 shown by dashed lines indicates the position of the first partial region 7 with respect to the first region 3 represented by the first image 15.

Corresponding image positions in the first image 15 and the second image 17 are determinable using the first assignment 21, which is symbolized by two arrows. Corresponding image positions represent the same location of the object 1 in different images. An image position 23 contained in the first image 15 and an image position 24 contained in the second image 17, each of the image positions being highlighted by a cross, represent the same location 25 of the object 1 (cf. FIG. 1). An image position 27 contained in the first image 15 and an image position 28 contained in the second image 17, each of which image positions are highlighted by a circle, represent another same location 29 of the object 1 (cf. FIG. 1).

The first assignment can be determined for example by applying a correlation between the first image 15 and the second image 17. In association with FIG. 3, an explanation has been given of the determination of the first assignment with reference to the first image 15 and the second image 17 which represents the first partial region 7. The first assignment between the first image 15 and the further second images 17 is furthermore determined in the same way.

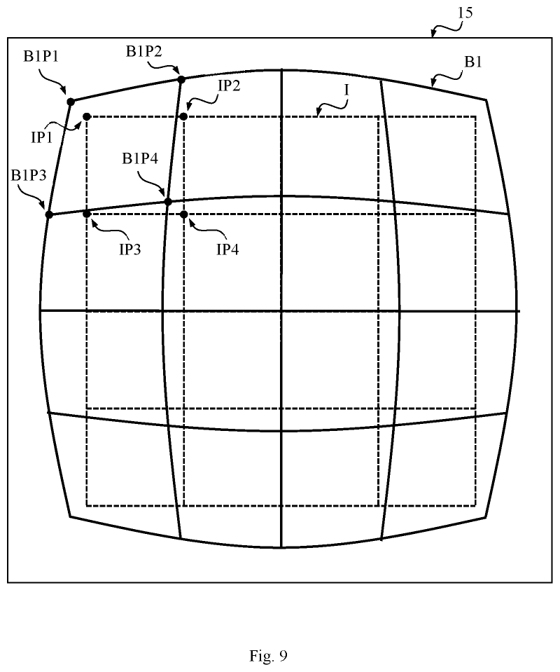

As a result of determining the first assignment, corresponding image positions in the first image 15 and the second images are known. Image recording aberrations are more highly pronounced in the first image 15 than in the second images. By virtue of this difference, it is possible to determine a value of an image recording aberration of the image recording device on the basis of the first image 15 and the second images 17. One example for the determination of the image recording aberration is elucidated later with reference to FIGS. 9 to 11.

For this purpose, the image values of the first image 15 and of the second images 17 can be computed with one another, in particular at corresponding image positions 23, 24 and 27, 28, respectively, determined using the first assignment. First intermediate values can be determined from this computation, which first intermediate values can in turn be used for determining the value of the image recording aberration. By way of example, the deviation between image values at corresponding image positions 23, 24 and 27, 28, respectively, is determined and the value of the image recording aberration is determined on the basis thereof.

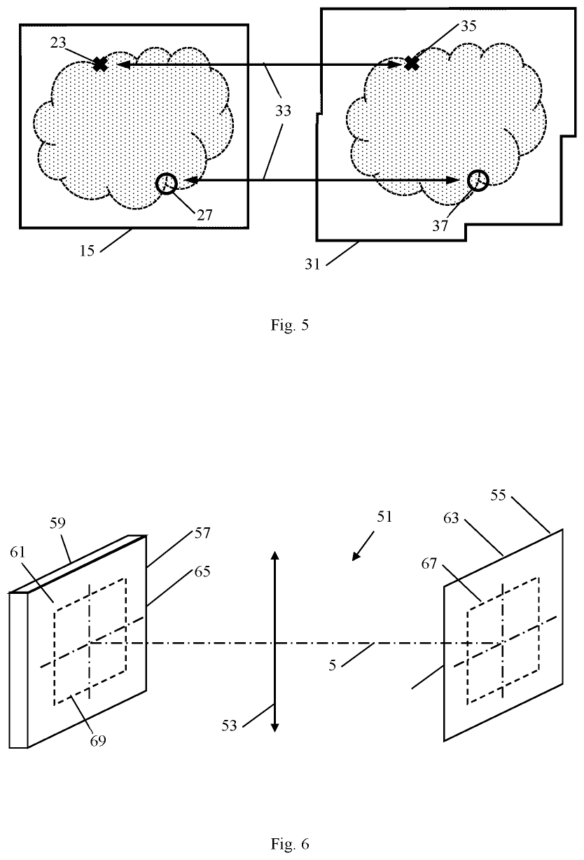

A further embodiment of a method for determining an image recording aberration is described with reference to FIGS. 4 and 5. The method includes recording the first image 15 and recording the second images 17 as explained in association with FIGS. 1 and 2A to 2D.

The method furthermore includes generating a third image 31 using the second images 17, the third image being illustrated by way of example in FIG. 4. For comparison with the first image 15, the first region 3 represented by the first image 15 is illustrated by a dash-dotted rectangle in FIG. 4. For comparison with the second images 17, the partial regions 7, 9, 11, 13 represented by the second images 17 are illustrated by dotted rectangles.

The third image 31 represents the first region 3 of the object 1. The third image 31 is generated for example by the second images 17 being combined as illustrated in FIG. 4. Corresponding image regions of the second images 17 are superimposed in each case such that each pixel of the third image 31 is assigned exactly one location of the first region 3. By way of example, corresponding image regions of the second images 17 are identified by correlation of the second images 17. Consequently, the second images 17 can be combined such that corresponding image regions of the second images 17 overlap one another.

Image values of the third image 31 at pixels which correspond to corresponding image regions of the second images 17 can be determined in various ways. By way of example, the image values at the pixels are determined by averaging the image values at corresponding image regions of the second images 17. Alternatively, the image values of the third image 31 at the pixels can be taken over from one of the second images 17 at corresponding image positions.

The third image 31 is therefore an image of the first region 3 of the object 1, but has smaller image recording aberrations compared with the first image 15 since the third image 31 is generated from the second images 17.

In accordance with this embodiment, the value of the image recording aberration of the image recording device is determined on the basis of the third image 31. By way of example, the value of the image recording aberration is determined by a comparison of the first image 15 with the third image 31. This can be carried out for example by a second assignment being determined, by which corresponding image positions in the first image 15 and the third image 31 are determinable, and by image values of the first image 15 and of the third image 31 at corresponding image positions being computed with one another. This is explained in association with FIG. 5.

FIG. 5 shows a schematic illustration for elucidating the second assignment. FIG. 5 shows the first image 15 and the third image 31. Corresponding image positions in the first image 15 and the third image 31 are determinable using the second assignment 33, which is symbolized by two arrows. An image position 23 contained in the first image and an image position 35 contained in the third image 31, each of the image positions being highlighted by a cross, represent the same location 25 of the object 1 (cf. FIG. 1). An image position 27 contained in the first image and an image position 37 contained in the third image 31, each of which image positions are highlighted by a circle, represent the further same location 29 of the object 1 (cf. FIG. 1). The second assignment 33 can be determined for example by applying a correlation between the first image 15 and the third image 31.

As a result of determining the second assignment 33, corresponding image positions 23, 35 and 27, 37, respectively, in the first image 15 and the third image 31 are known. Image recording aberrations are more highly pronounced in the first image 15 than in the third image 31. By virtue of this difference, it is possible to determine a value of an image recording aberration of the image recording device on the basis of the first image 15 and the third image 31. For this purpose, the image values of the first image 15 and of the third image 31 can be computed with one another, in particular at corresponding image positions 23, 35 and 27, 37, respectively, determined using the second assignment 33. Second intermediate values can be determined from this computation, which second intermediate values can in turn be used for determining the value of the image recording aberration. By way of example, the deviation between image values at corresponding image positions 23, 35 and 27, 37, respectively, is determined and the value of the image recording aberration is determined on the basis thereof.

FIG. 9 shows a schematic illustration for elucidating an image recording aberration in a first image 15. The first image 15 was recorded with a small magnification and therefore shows a large region 3 of the object 1 (cf. FIG. 1). The image distortion shown in FIG. 9 is a so-called barrel distortion. The barrel distortion serves as an illustrative example of the image recording aberration. However, the explanations in respect of the meaning, determination and application of the image recording aberration also hold true for other types of image recording aberrations.

A grid illustrated by dashed lines represents image positions I, such as would be imaged by an ideal image recording of object locations arranged in the form of a grid. In the present case, ideal imaging means an object magnification that is constant in the vertical and horizontal directions. In the description, reference is explicitly made to the image positions IP1, IP2, IP3 and IP4 of the image positions I. These image points are highlighted by circular areas.

A distorted grid illustrated by solid lines represents image positions B1 such as would be imaged by a real image recording—carried out using an image recording device 51, 101, 102—of the object locations which are arranged in the form of a grid and which would be imaged onto the image positions I during ideal imaging. In the description, reference is made explicitly to the image positions B1P1, B1P2, B1P3 and B1P4 of the image positions B1. These image points are highlighted by circular areas.

A first object location is imaged onto the image position IP1 during the ideal imaging and is imaged onto the image position B1P1 during the real imaging. A second object location is imaged onto the image position IP2 during the ideal imaging and is imaged onto the image position B1P2 during the real imaging. A third object location is imaged onto the image position IP3 during the ideal imaging and is imaged onto the image position B1P3 during the real imaging. A fourth object location is imaged onto the image position IP4 during the ideal imaging and is imaged onto the image position B1P4 during the real imaging.

The image positions IP1 and B1P1 are at a distance from one another. The image positions IP2 and B1P2 are at a distance from one another. The image positions IP3 and B1P3 are at a distance from one another. The image positions IP4 and B1P4 are at a distance from one another. That means that the image recording exhibits aberrations. The distances are not constant. That means that the real image recording is subject to a distortion aberration. The distance between an image position produced by the ideal image recording and an image position produced by the real image recording increases with increasing distance from the image center, which is caused by the increasing distance between the object location imaged onto the image positions and the optical axis of the image recording device.

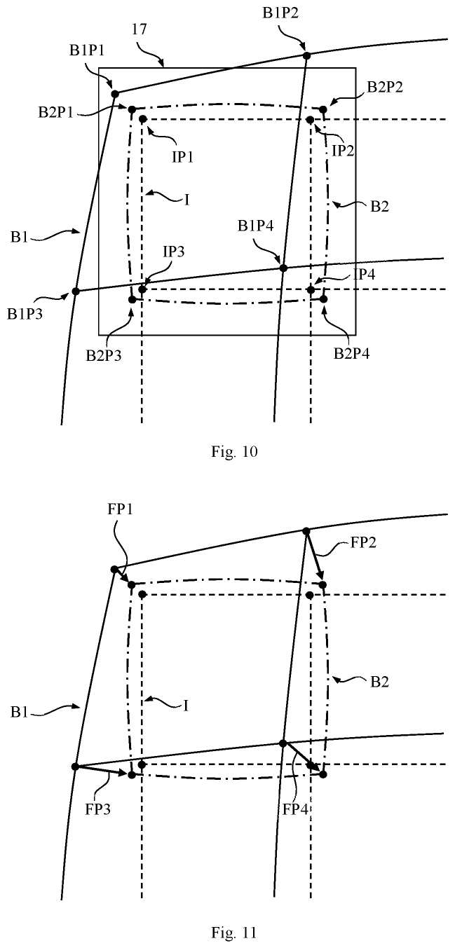

FIG. 10 shows a schematic illustration for elucidating an image recording aberration in a second image 17. The second image 17 represents a partial region 7 of the object 1 (cf. FIG. 2A), wherein the partial region 7 is smaller than the partial region 3 represented by the first image 15 in FIG. 9. The second image 17 was recorded with a magnification but is larger than the magnification with which the first image 15 shown in FIG. 9 was recorded. Therefore, the second image 17 represents a smaller partial region 7 of the object 1 in comparison with FIG. 9.

A grid illustrated by dashed lines represents image positions I such as would be imaged by an ideal recording of object locations, wherein the object locations are identical to those which are imaged by the ideal imaging onto the grid illustrated using dashed lines in FIG. 9. The distance between the lines of the grid in FIG. 10 is greater than in FIG. 9 on account of the larger magnification of the second image 17. Accordingly, the image positions IP1 in FIGS. 9 and 10 both represent the first object location; the image positions IP2 in FIGS. 9 and 10 both represent the second object location; the image positions IP3 in FIGS. 9 and 10 both represent the third object location; and the image positions IP4 in FIGS. 9 and 10 both represent the fourth object location.

A distorted grid illustrated by dash dotted lines represents image positions B2 such as would be imaged by a real image recording—carried out using the image recording device 51, 101, 102—of the object locations which are arranged in the form of a grid and which would be imaged onto the image positions I during ideal imaging. In the description, reference is made explicitly to the image positions B2P1, B2P2, B2P3 and B2P4 of the image positions B2. These image positions are highlighted by circular areas.

The first object location is imaged onto the image position IP1 during the ideal imaging and is imaged onto the image position B2P1 during the real imaging. The second object location is imaged onto the image position IP2 during the ideal imaging and is imaged onto the image position B2P2 during the real imaging. The third object location is imaged onto the image position IP3 during the ideal imaging and is imaged onto the image position B2P3 during the real imaging. The fourth object location is imaged onto the image position IP4 during the ideal imaging and is imaged onto the image position B2P4 during the real imaging.

FIG. 10 furthermore shows, using solid lines, a part of the grid which represents the image positions B1 in FIG. 9, wherein the grid was adapted to the magnification of the second image 17. The image position B1P1 in the first image 15 and the image position B2P1 in the second image 15 both represent the first object location and are therefore corresponding image positions. The image position B1P2 in the first image 15 and the image position B2P2 in the second image 15 both represent the second object location and are therefore corresponding image positions. The image position B1P3 in the first image 15 and the image position B2P3 in the second image 15 both represent the third object location and are therefore corresponding image positions. The image position B1P4 in the first image 15 and the image position B2P4 in the second image 15 both represent the fourth object location and are therefore corresponding image positions.

In FIG. 10, the image positions IP1 and B2P1 are at a distance from one another, but the distance is smaller than the distance between the image positions IP1 and B1P1. The image positions IP2 and B2P2 are at a distance from one another, but the distance is smaller than the distance between the image positions IP2 and B1P2. The image positions IP3 and B2P3 are at a distance from one another, but the distance is smaller than the distance between the image positions IP3 and B1P3. The image positions IP4 and B2P4 are at a distance from one another, but the distance is smaller than the distance between the image positions IP4 and B1P4. The fact that the distances between the ideal and real image positions in the second image 17 are smaller than in the first image 15 is owing to the fact, for example, that the image positions in the first image 15 are comparatively further away from the optical axis of the image recording device than in the second image 17 and are thus affected by the distortion to a greater extent. A further reason is the higher magnification of the second image 17 with approximately identically manifested distortion in the first and second images.

FIG. 11 shows a schematic illustration of the image recording aberration such as is determined from the first image 15 shown in FIG. 9 and the second image 17 shown in FIG. 10. The image positions B1P1 and B2P1, which are corresponding image positions, are identified using known methods in the first image 15 and the second image 17 (or a third image composed of the second images, see FIG. 4). This is carried out using (local) correlation methods, for example. The further corresponding image positions B1P2 and B2P2, B1P3 and B2P3, B1P4 and B2P4 are determined in an analogous manner.

The distance and a displacement direction between the corresponding image positions are determined on the basis of the corresponding image positions. In FIG. 11, FP1 represents a displacement vector having a length and a direction and indicating the distance and the displacement direction between the corresponding image positions B1P1 and B2P1. FP2 represents a displacement vector indicating the distance and the displacement direction between the corresponding image positions B1P2 and B2P2. FP3 represents a displacement vector indicating the distance and the displacement direction between the corresponding image positions B1P3 and B2P3. FP4 represents a displacement vector indicating the distance and the displacement direction between the corresponding image positions B1P4 and B2P4.

The displacement vectors FP1, FP2, FP3 and FP4 indicate the image recording aberration, wherein the image positions of the second image 17 (or respectively of the third image, cf. figure 4) are regarded as a valid approximation of the ideal image recording. Accordingly, the image recording aberration represents the difference between the real image position and the ideal image position of an object location for a multiplicity of object locations.

The image recording aberration which was determined in the form of the displacement vectors FP1, FP2, FP3 and FP4 can be used for correcting the image positions of the first image 15 in FIG. 9. Referring to FIG. 9, the image position B1P1 can be displaced by the displacement vector FP1 scaled to the magnification of the first image 15. The image recording aberration concerning the imaging of the first object location in the first image 15 is reduced as a result. The further image positions B1P2, B1P3, B1P4 (generally the image positions B1) are changed in a corresponding manner and the image recording aberration is thereby reduced.

The image recording aberration that was determined in the form of the displacement vectors FP1, FP2, FP3 and FP4 is a general correction rule that can be used for the image correction of an arbitrary image which is recorded with the same magnification as the first image 15. By way of example, a new image (of a different object) can be recorded with a magnification the same as or comparable to that of the first image 15. The image recording aberration determined as above on the basis of the first image 15 and the second image 17 can be stored in a memory. For the correction of the newly recorded image, the image recording aberration is read from the memory in which the image recording aberration is stored, and is applied to the newly recorded image in the manner as was described with reference to FIG. 9.

The image recording aberration that was determined in the form of the displacement vectors FP1, FP2, FP3 and FP4 can be the optimization target of an optimization algorithm which changes the operating parameters of the image recording device which influence the image recording such that the optimization target becomes better. By way of example, the optimization algorithm implements an iterative method in which the operating parameters of the image recording device which influence the image recording are changed in each iteration. In each iteration, a new image (with a magnification that substantially corresponds to the magnification of the first image 15) is recorded and the image recording aberration is determined once again. In this case, the method changes the operating parameters such that the image recording aberration is reduced or a metric based thereon (for example the average value of the lengths of the displacement vectors FP1, FP2, FP3 and FP4 or the like) is optimized.

The methods described herein can be carried out using a multiplicity of different image recording devices. Examples of such image recording devices are described in association with FIGS. 6 to 8.

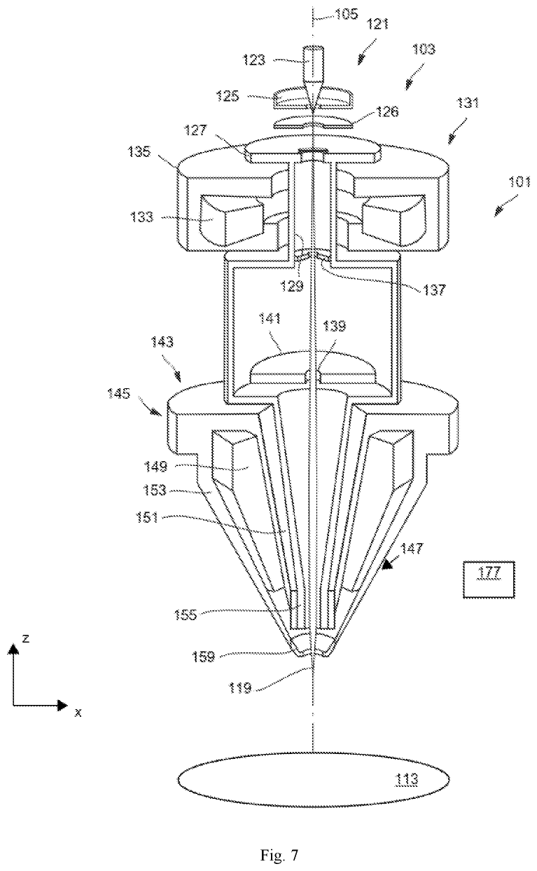

FIG. 7 shows a simplified schematic illustration of a light microscope 51. The light microscope 51 includes an imaging device 53 configured to image an object plane 55 into an image plane 57. The imaging device 53 includes for example one or a plurality of lenses, which together form an objective. The imaging device 53 has the optical axis 5.

The light microscope 51 furthermore includes an image sensor 59, the detection area 61 of which is arranged in the image plane 57. The image sensor 59 is configured to record images.

In the methods described herein, the first image 15 can be recorded with a first magnification and the second images 17 can be recorded with second magnifications, wherein each of the second magnifications is greater than the first magnification.

In association with the imaging device 53, the magnification can be defined as the ratio between the size of an image field and the size of a field of view. By way of example, the first image 15 is recorded with the field of view 63 and the image field 65. The image field 65 extends over the entire detection area 61.

The second images 17 can be recorded with a field of view 67 and the image field 65. Since the field of view 63 with which the first image 15 is recorded is larger than the field of view 67 with which the second images 17 are recorded, and both the first image 15 and the second images 17 are recorded with the image field 65, the magnification with which the second images 17 are recorded is greater than the magnification with which the first image 15 is recorded.

However, the first image 15 and the second images 17 can also be recorded with the same magnification, but with different field of view sizes. By way of example, the first image 15 is recorded with the field of view 63 and the image field 65. The second images 17 are recorded with the field of view 67 and an image field 69. The ratio of the image field 65 to the field of view 63 is equal to the ratio of the image field 69 to the field of view 67, such that the first image and the second images are recorded with the same magnification. However, the field of view 67 with which the second images 17 are recorded is smaller than the field of view 63 with which the first image 15 is recorded. Moreover, the image field 69 with which the second images 17 are recorded is smaller than the image field 65 with which the first image 15 is recorded.

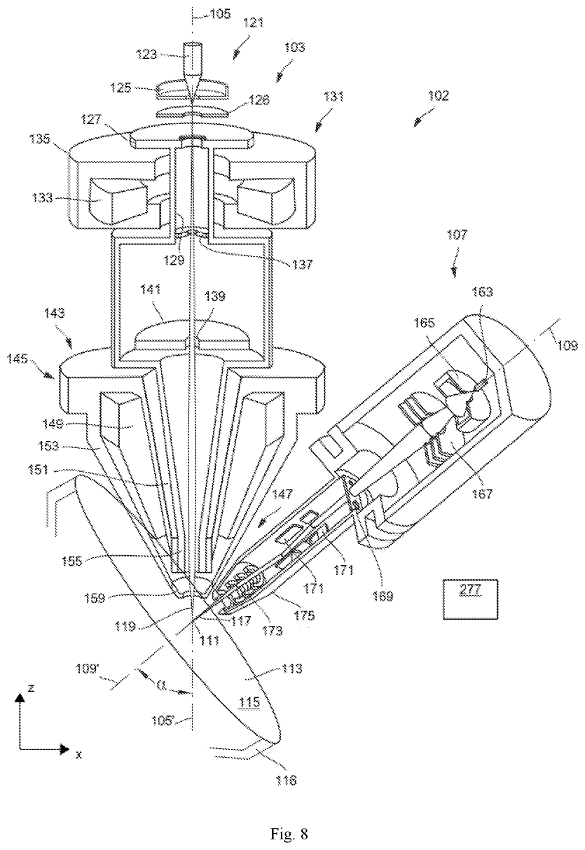

The methods described herein can furthermore be carried out with the particle beam systems described with reference to FIGS. 7 and 8.

FIG. 7 shows, in a perspective and schematically simplified illustration, a particle beam system 101 including an electron beam microscope 103 having a particle-optical axis 105.

The electron beam microscope 103 is configured to generate a primary electron beam 119, which is emitted along the particle-optical axis 105 of the electron beam microscope 103, and to direct the primary electron beam 119 onto an object 113.

For the purpose of generating the primary electron beam 119, the electron beam microscope 103 includes an electron source 121, which is illustrated schematically by a cathode 123 and a suppressor electrode 125, and an extractor electrode 126 arranged at a distance therefrom. Furthermore, the electron beam microscope 103 includes an acceleration electrode 127, which transitions into a beam tube 129 and passes through a condenser arrangement 131, which is illustrated schematically by a toroidal coil 133 and a yoke 135. After passing through the condenser arrangement 131, the primary electron beam 119 passes through a pinhole stop 137 and a central hole 139 in a secondary particle detector (for example a secondary electron detector) 141, whereupon the primary electron beam 119 enters an objective lens 143 of the electron microscope 103. The objective lens 143 includes a magnetic lens 145 and an electrostatic lens 147 for focusing the primary electron beam 119. The magnetic lens 145 includes a toroidal coil 149, an inner pole shoe 151 and an outer pole shoe 153. The electrostatic lens 147 is formed by a lower end 155 of the beam tube 129, the inner lower end of the outer pole shoe 153, and a toroidal electrode 159 tapering conically towards the object 113.

Although not illustrated in FIG. 7, the electron beam microscope 103 furthermore includes a deflector device for deflecting/diverting the primary electron beam 119 in directions that are orthogonal to the particle-optical axis 105.

The particle beam system 101 furthermore includes a controller 177, which controls the operation of the particle beam system 101. In particular, the controller 177 controls the operation of the electron beam microscope 103. The controller 177 receives from the secondary particle detector 141 a signal representing the detected secondary particles which are generated by the interaction of the object 113 with the primary electron beam 119 and are detected by the secondary particle detector 141. The controller 177 can furthermore include an image processing device and be connected to an image reproduction device (not illustrated). Instead of being arranged within the electron beam microscope 103, the secondary particle detector 141 can also be arranged within a vacuum chamber, which includes the object 113, but outside the electron beam microscope 103.

FIG. 8 shows, in a perspective and schematically simplified illustration, a particle beam system 102 including an ion beam system 107 having a particle-optical axis 109 and the electron beam microscope 103 described with reference to FIG. 7.

The particle-optical axes 105 and 109 of the electron beam microscope 103 and of the ion beam system 107 intersect at a location 111 within a common working region at an angle α, which can have values of for example 45° to 55° or approximately 90°, such that an object 113 to be analysed and/or to be processed and having a surface 115 in a region of the location 111 can be imaged or processed using an ion beam 117 emitted along the particle-optical axis 109 of the ion beam 107 and can additionally be analysed using an electron beam 119 emitted along the particle-optical axis 105 of the electron beam microscope 103. A mount 116 indicated schematically is provided for mounting the object 113, which mount can set the object 113 with regard to distance from and orientation with respect to the electron beam microscope 103 and the ion beam system 107.

The ion beam system 107 includes an ion source 163 having an extraction electrode 165, a condenser 167, a stop 169, deflection electrodes 171 and a focusing lens 173 for generating the ion beam 117 emerging from a housing 175 of the ion beam system 107. The longitudinal axis 109′ of the mount 116 is inclined with respect to the vertical 105′ by an angle which in this example corresponds to the angle α between the particle-optical axes 105 and 109. However, the directions 105′ and 109′ do not have to coincide with the particle-optical axes 105 and 109, and the angle formed by them also does not have to correspond to the angle α between the particle-optical axes 105 and 109.

The particle beam system 102 furthermore includes a controller 277, which controls the operation of the particle beam system 102. In particular, the controller 277 controls the operation of the electron beam microscope 103 and of the ion beam system 107. The particle beam system 102 can furthermore include a detector for backscattered ions or secondary ions (not shown).

What is claimed is:

1. A method, comprising:
using an image recording device to record a first image representing a first region of an object;
using the image recording device to record second images representing mutually different partial regions of the first region of the object), each of the partial regions being smaller than the first region; and
determining a value of an image recording aberration of the image recording device on the basis of the first image and the second images.

2. The method of claim 1, wherein:
determining the value of the image recording aberration of the image recording device comprises determining first intermediate values via image values of the first image and of the second images at corresponding image positions being computed with one another, corresponding image positions representing the same location of the object in the first image and the second images; and
the value of the image recording aberration of the image recording device is determined on the basis of the first intermediate values.

3. The method of claim 2, further comprising determining a first assignment, by which corresponding image positions in the first image and the second images are determinable via correlation of the first image with the second images,
wherein the first intermediate values are determined by image values of the first image and of the second images at corresponding image positions determined via the first assignment being computed with one another.

4. The method of claim 2, wherein computing the image values of the first image and of the second images comprises determining a deviation between image values of the first image and of the second images at corresponding image positions.

5. The method of claim 1, further comprising generating a third image on the basis of the second images, wherein the third image represents the first region of the object, and the value of the image recording aberration is determined on the basis of the third image.

6. The method of claim 5, wherein generating the third image comprises:
combining the second images so that exactly one location of the object is assigned to each pixel of the third image; and/or
correlating the second images.

7. The method of claim 5, wherein:
determining the value of the image recording aberration of the image recording device comprises determining second intermediate values by image values of the first image and of the third image at corresponding image positions being computed with one another;
corresponding image positions represent a same location of the object in the first image and the third image; and
the value of the image recording aberration of the image recording device is determined on the basis of the second intermediate values.

8. The method of claim 7, further comprising determining a second assignment, by which corresponding image positions in the first image and the third image are determinable by correlation of the first image with the third image,
wherein the second intermediate values are determined by image values of the first image and of the third image at corresponding image positions determined via the second assignment being computed with one another.

9. The method of claim 7, wherein computing the image values of the first image and of the third image comprises determining a deviation between image values of the first image and of the third image at determined corresponding image positions.

10. The method of claim 1, wherein the first image is recorded with a first magnification, the second images with second magnifications, and each second magnification is greater than the first magnification.

11. The method of claim 10, wherein a ratio of the smallest second magnification to the first magnification is at least two.

12. The method of claim 1, wherein the first image is recorded with a first field of view size, the second images are recorded with second field of view sizes, and each of the second field of view sizes is smaller than the first field of view size.

13. The method of claim 12, wherein a ratio of the first field of view size to the largest second field of view size is at most two.

14. The method of claim 1, wherein:
the partial regions partly overlap one another; and/or
the partial regions together cover the first region.

15. The method of claim 1, wherein an optical axis of the image recording device passes through the partial regions during recording of the second images.

16. The method of claim 1, further comprising correcting the first image on the basis of the value of the image recording aberration.

17. The method of claim 1, further comprising:
recording a fourth image using the image recording device; and
correcting the fourth image on the basis of the value of the image recording aberration determined.

18. The method of claim 1, further comprising determining an operating parameter of the image recording device on the basis of the value of the image recording aberration so that the image recording aberration is reduced in comparison with the situation during the recording of the first image.

19. A system comprising:
an image recording device;
one or more processing devices; and
one or more machine-readable hardware storage devices comprising instructions that are executable by the one or more processing devices to perform the method of claim 1.

20. One or more machine-readable hardware storage devices comprising instructions that are executable by one or more processing devices to perform the method of claim 1.
